(19) United States
(12) Patent Application Publication
(10) Pub. No.: US 2006/0090997 A1
(43) Pub. Date: May 4, 2006

(54) Discharge surface-treatment method and discharge surface-treatment apparatus

(75) Inventors: Akihiro Goto, Tokyo (JP); Masao Akiyoshi, Tokyo (JP); Hiroyuki Ochiai, Tokyo (JP); Mitsutoshi Watanabe, Tokyo (JP); Takashi Furukawa, Tokyo (JP)

Correspondence Address: SUGHRUE MION, PLLC, 2100 PENNSYLVANIA AVENUE, N.W., SUITE 800, WASHINGTON, DC, 20037, US

(73) Assignees: MITSUBISHI DENKI KABUSHIKI KAISHA; ISHIKAWAJIMA-HARIMA HEAVY INDUSTRIES CO.

(21) Appl. No.: 11/298,493

(22) Filed: Dec. 12, 2005

Related U.S. Application Data
(63) Continuation-in-part of application No. PCT/JP04/00801, filed on Jan. 29, 2005.

(30) Foreign Application Priority Data
Jun. 11, 2003 (JP) 2003-166016

(51) Int. Cl. H05F 3/00; B01J 19/08

(52) U.S. Cl. 204/164; 422/186.04

(57) ABSTRACT

A discharge surface-treatment method includes generating a pulse-like discharge by using a green compact of metal powder, a metal compound powder, or a ceramic powder as an electrode and applying a voltage equal to or greater than 500 volts between the electrode and a workpiece in a gas atmosphere; and forming a coating consisting of an electrode material or a substance resulting from a reaction of the electrode material to the energy of the pulse-like discharge on a surface of the workpiece with an energy of the pulse-like discharge.

### BACKGROUND OF THE INVENTION

1) Field of the Invention

The present invention relates to a technology for a discharge surface treatment, and more particularly, to a discharge surface-treatment method and a discharge surface-treatment apparatus to form a coating consisting of an electrode material or a substance resulting from a reaction of an electrode material to a discharge energy on a workpiece by generating a pulse-like discharge between an electrode and the workpiece using a green compact of metal powder, a metal compound powder, or a ceramic powder as the electrode,

2) Description of the Related Art

In a conventional discharge surface treatment, a coating of a hard material, such as titanium carbide (TiC), is formed, with a principle objective of achieving abrasion resistance at room temperature. In recent years, however, there have been increasing demands for a technology of densely applying a thick metal material on a workpiece surface.

A background of this is an increasing demand for coatings with abrasion resistance at a high temperature environment or a lubrication property. By way of example, a case of a turbine blade of a gas turbine engine for aircraft shown in FIG. 10 is described.

As shown in FIG. 10, a turbine blade 101 have a plurality of blades contacted and fixed thereto, the blades being configured to rotate about a shaft (not shown). When these blades rotate, a contact portion among the blades is subjected to severe rubbing and beating under a high temperature environment.

Under such a high temperature environment (over 700° C.) where a turbine blade is used, normal anti-abrasion coating or coating with a lubrication property for use at room temperature can hardly achieve its effect because the coating is oxidized under a high temperature environment. Therefore, for members for use under a high temperature environment, a coating (thick coating) made of an alloy material including a metal for generating an oxide that exerts a lubrication property is formed through a scheme, such as welding and spray coating.

These schemes require skilled manual operations. Concentrated heat input to a workpiece (for welding) pose many problems such that deformation, cracking, and the like are prone to occur. To get around the problems, a coating formation technology serving as an alternative to these schemes is required.

On the other hand, as a coating formation technology, a method of forming a coating on a workpiece surface with a pulse-like discharge (hereinafter a discharge surface treatment) has been suggested (see, for example, Japanese Patent No. 3227454). Conventionally, in a conventional discharge surface treatment, a principle objective is to achieve abrasion resistance at room temperature, and a coating of a hard material, such as TiC, is formed.

In recent years, however, there have been increasing demands for formation of not only a hard ceramic coating with a view to abrasion resistance at room temperature but also a thick coating with a coating thickness on the order of 100 micrometers by using a discharge surface treatment. However, when a discharge surface treatment is performed in dielectric fluid, particularly oil, carbon in oil and metal react with each other to form carbide. Therefore, it is extremely difficult to form a thick coating made of material prone to form carbide, such as titanium (Ti), by using a discharge surface treatment.

Moreover, other than the above, coating molding technologies using a discharge in a gas atmosphere have been suggested (see, for example, Japanese Patent Application Laid-Open Publication No. 6-269936 and Japanese Patent Application Laid-Open Publication No. 11-264080). However, these methods are those of forming a coating by manually applying a voltage of 80 volts to 200 volts between a rotating electrode and a workpiece to repeat discharge and contact. Therefore, it is difficult to stably form a coating.

Based on the background described above, in recent years, there have been desperate demands for a technology of forming a hard ceramic coating with a view to abrasion resistance at room temperature but also a thick coating with a coating thickness on the order of 100 micrometers by using a discharge surface treatment that can be made on a line basis without requiring skilled manual operations.

However, in the electrode manufacturing method disclosed in Japanese Patent No. 3227454 mentioned above, a main subject is to form a thin coating, and therefore it is impossible to form a coating with abrasion resistance at a high temperature environment or a lubricity property. Also, no consideration is given to formation of an electrode with a uniform hardness at the time of compressing and molding a powder, and therefore the hardness of the electrode itself may vary.

In forming a thick coating through a discharge surface treatment, supply of the electrode material from the electrode side and how the supplied material is melted on the workpiece surface have the most influences on coating performance. The supply of the electrode material is influenced by the strength, that is, hardness, of the electrode. In forming a thin coating by using the technology disclosed in Japanese Patent No. 3227454, the thickness of the coating to be formed is thin. Therefore, even if the hardness of the electrode is not uniform to some degree, the hardness has little influence on the coating performance.

However, if a discharge surface treatment is performed by using such an electrode having a non-uniform strength, it is impossible to form a coating with a uniform thickness. In forming a thick coating through a discharge surface treatment, a coating with a uniform thickness can be formed only by uniformly supplying a large amount of the electrode material to a process area of the workpiece side. Therefore, if the electrode has a portion that is even slightly non-uniform, the way how the coating is formed at that portion is changed, thereby making it impossible to form a coating with a uniform thickness.

Moreover, depending on the portion of the electrode for use in the discharge surface treatment, a coating forming speed and a coating property vary, for example, thereby making it impossible to perform a surface treatment with stable quality.

### SUMMARY OF THE INVENTION

It is an object of the present invention to solve at least the above problems in the conventional technology.

A discharge surface-treatment method according to one aspect of the present invention includes generating a pulse-like discharge by using a green compact of metal powder, a metal compound powder, or a ceramic powder as an electrode and applying a voltage equal to or greater than 500 volts between the electrode and a workpiece in a gas atmosphere; and forming a coating consisting of an electrode material or a substance resulting from a reaction of the electrode material to the energy of the pulse-like discharge on a surface of the workpiece with an energy of the pulse-like discharge.

A discharge surface-treatment apparatus according to another aspect of the present invention includes an electrode formed of a green compact of metal powder, a metal compound powder, or a ceramic powder; a power supply that applies a voltage equal to or greater than 500 volts between the electrode and a workpiece to generate a pulse-like discharge; and a gas supplying unit that supplies a gas to the electrode and the workpiece. A coating consisting of an electrode material or a substance resulting from a reaction of the electrode material to the energy of the pulse-like discharge is formed on a surface of the workpiece with an energy of the pulse-like discharge.

A discharge surface-treatment method according to still another aspect of the present invention includes generating a pulse-like discharge by using a green compact of metal powder, a metal compound powder, or a ceramic powder as an electrode and applying a voltage equal to or greater than 500 volts between the electrode and a workpiece in an inert-gas atmosphere in a liquid state; and forming a coating consisting of an electrode material or a substance resulting from a reaction of the electrode material to the energy of the pulse-like discharge on a surface of the workpiece with an energy of the pulse-like discharge.

A discharge surface-treatment apparatus according to still another aspect of the present invention includes an electrode formed of a green compact of metal powder, a metal compound powder, or a ceramic powder; a storing unit that stores an inert gas in a liquid state; and a power supply that generates a pulse-like discharge between the electrode and a workpiece. A coating consisting of an electrode material or a substance resulting from a reaction of the electrode material to the energy of the pulse-like discharge is formed on a surface of the workpiece with an energy of the pulse-like discharge.

A discharge surface-treatment method according to still another aspect of the present invention includes generating a pulse-like discharge by using a metal mainly consisting of an aluminum as an electrode and applying a voltage equal to or greater than 500 volts between the electrode and a workpiece in a gas atmosphere, or in a working liquid; and forming a coating consisting of an electrode material or a substance resulting from a reaction of the electrode material to the energy of the pulse-like discharge on a surface of the workpiece with an energy of the pulse-like discharge.

The other objects, features, and advantages of the present invention are specifically set forth in or will become apparent from the following detailed descriptions of the invention when read in conjunction with the accompanying drawings.

### BRIEF DESCRIPTION OF THE DRAWINGS

FIG. 1 is a section view depicting a concept of a process of manufacturing an electrode for discharge surface treatment;

FIG. 2 is a conceptual view of a state of performing a discharge surface treatment;

FIG. 3A is a plot of a voltage waveform during a discharge surface treatment;

FIG. 3B is a plot of a current waveform with respect to the voltage waveform of FIG. 3B;

FIG. 4 is a view of an electric discharging state in dielectric fluid;

FIG. 5 is a plot of a relation between a no-load voltage and an inter-electrode distance;

FIG. 6 is a conceptual view of a state of performing a discharge surface treatment according to a second embodiment;

FIG. 7 is a conceptual view of a state of performing a discharge surface treatment according to a third embodiment;

FIG. 8 is a conceptual view of a state of performing a discharge surface treatment according to a fourth embodiment;

FIG. 9 is a conceptual view of a state of performing a discharge surface treatment according to a fifth embodiment; and

FIG. 10 is a turbine blade of a gas turbine engine for aircraft.

### DETAILED DESCRIPTION

Exemplary embodiments of a discharge surface-treatment method and a discharge surface-treatment apparatus according to the present invention are described in detail below with reference to the accompanying drawings. Note that the present invention is not restricted to the following description, but can be changed as appropriate within a scope not deviating from the gist of the present invention. Also, in the attached drawings, a scale of each member may differ for the purpose of easy understanding.

Functions required for a thick coating to be formed through a discharge surface treatment according to the present invention include abrasion resistance under a high temperature environment and a lubrication property. Therefore, the present invention is targeted for discharge surface-treatment technology that can also be utilized for components to be used under a high temperature environment as well.

To form a thick coating, unlike a conventional electrode whose main ingredient is ceramic to be used for forming a hard ceramic coating, an electrode formed by compressing and molding a powder whose main ingredient is a metal component and then performing a heating process as required is used.

Here, when a thick coating is formed through a discharge surface treatment, in order to supply a large amount of electrode material through a pulse of a discharge, it is required that the electrode should have a predetermined feature regarding the properties of the material and hardness of the electrode, such that the electrode the hardness of the electrode is decreased to some degree.

When a thick coating is formed through a pulse discharge, as described above, an electrode made of a material whose main ingredient is a metal component is used. However, studies by the inventors have found that, if the electrode contains a large amount of material prone to form carbide, the material prone to form carbide reacts with carbon contained in oil, which is dielectric fluid, to become carbide, thereby making it difficult to form a thick coating.

That is, the studies by the inventors have found that, when a coating is formed from an electrode manufactured by compressing and molding a powder on the order of several micrometers, it is difficult to form a stable, dense, and thick coating unless a material not prone to form carbide, such as Co (cobalt), Ni (nickel), and Fe (iron), is contained in the electrode.

However, some demands in industry for formation of a thick coating include those for maintenance using a material, such as Ti (titanium), that is extremely prone to carbide. The present invention provides a technique allowing a dense thick coating to be stably formed with a pulse discharge even when such a material extremely prone to carbide.

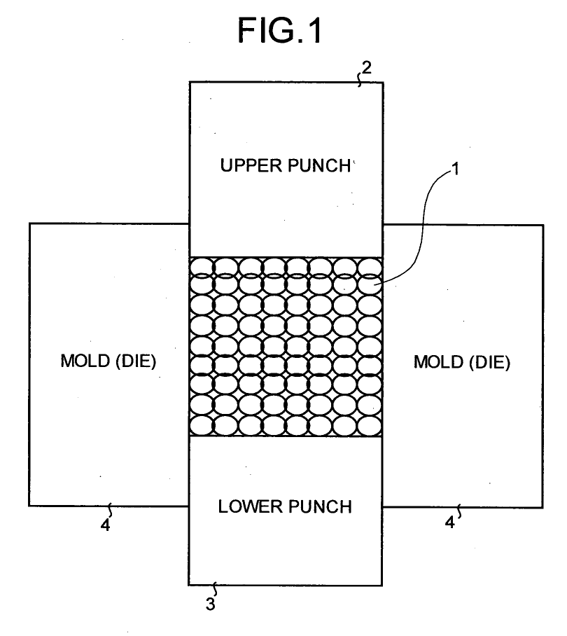

FIG. 1 is a section view depicting a concept of a process of manufacturing an electrode for discharge surface treatment according to a first embodiment of the present invention. As an example of the electrode for use in the present invention, description is made to the case where a Co alloy power is used as an electrode material, with reference to FIG. 1. As shown in FIG. 1, in a space surrounded by a mold's upper punch 2, a mold's lower punch 3, and a mold's die 4, a Co powder 1 having a particle diameter on the order of 1 micrometer is filled. Then, by compressing and molding this powder, a molded-powder is formed. In a discharge surface treatment, this molded-powder is used as a discharge electrode.

The electrode manufacturing process shown in FIG. 1 is as follows. First, the Co powder 1 is put in the mold, and a predetermined pressure is applied to the Co powder 1 by the upper punch 2 and the lower punch 3, thereby causing the Co powder 1 to coagulate to become a compression.

At the time of pressing, to improve transmission of a pressure of a press into the inside of the Co powder 1, approximately 1 weight percent to 10 weight percent of wax, such as paraffin, is preferably mixed in the Co powder 1 to improve moldability of the Co powder 1. However, as the residual amount of wax in the electrode is larger, electric conductivity becomes deteriorated at the time of a discharge surface treatment. Therefore, when wax is mixed in the Co powder 1, the wax is preferably removed in a later process.

The molded-powder formed through compression molding can be directly used as an electrode for discharge surface treatment as long as the molded-powder has a predetermined hardness and conductivity provided through compression. If the molded-powder obtained through compression molding does not have a predetermined hardness, the strength, i.e., hardness, can be increased by heating, thereby reducing electric resistance.

Here, when the molded-powder is used as being heated, it is preferable, also in view of handling, that the molded-powder be heated to have hardness similar to that of chalk and then be used as an electrode for discharge surface treatment. In addition, when wax is mixed at the time of compressing and molding as described above, the electrode (molded-powder) is required to be heated for removing wax.

At this time, the Co powder 1 to be put in the mold has an average particle system equal to or smaller than approximately 3 micrometers, more preferably, approximately 1 micrometer as described in the first embodiment.

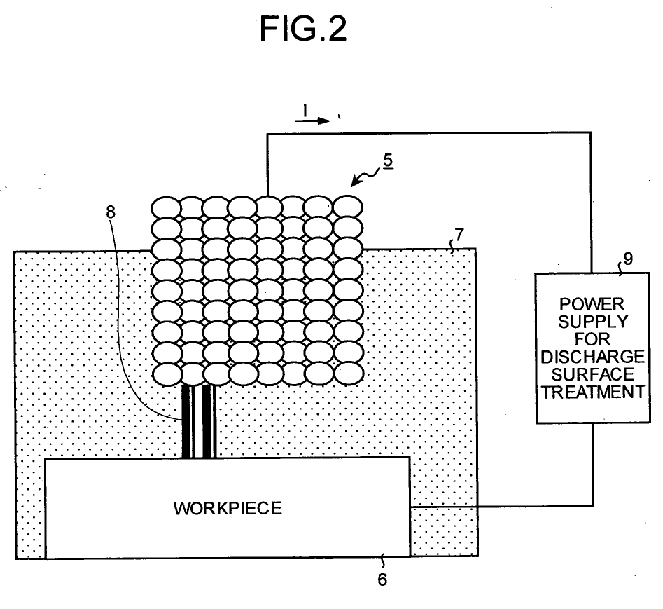

FIG. 2 depicts a conceptual view of a state of performing a discharge surface treatment by a discharge surface-treatment apparatus using an electrode for discharge surface treatment manufactured in the above process, the electrode having a low hardness for forming a thick coating. In FIG. 2, the state of occurrence of a pulse-like discharge is shown.

As shown in FIG. 2, the discharge surface-treatment apparatus according to the first embodiment includes an electrode for discharge surface treatment 5 (which may be hereinafter simply an electrode 5), the electrode being the electrode for discharge surface treatment described above and being formed of a molded-powder obtained by compressing and molding the Co powder 1 or the molded-powder subjected to a heating process; argon 7, which is a gas covering the electrode 5 and the workpiece 6; and a power supply for discharge surface treatment 9 that causes a pulse-like discharge (arc column 8) by applying a voltage between the electrode 5 and the workpiece 6. Here, in FIG. 2, a servo mechanism for controlling an inter-electrode distance, that is, a distance between the electrode 5 and the workpiece 6, a depot that stores the argon 7, and others are not directly related to the present invention, and therefore are omitted herein.

To form a coating on the workpiece surface by this discharge surface-treatment apparatus, the electrode 5 and the workpiece 6 are placed to be opposite to each other in an argon atmosphere. Then, in the argon atmosphere, the power supply for discharge surface treatment 9 is used to cause a pulse-like discharge between the electrode 5 and the workpiece 6. Specifically, a voltage is applied between the electrode 5 and the workpiece 6 to cause a pulse-like discharge. The discharge arc column 8 occurs, as shown in FIG. 2, between the electrode 5 and the workpiece 6.

With the discharge energy generated to take place between the electrode 5 and the workpiece 6, a coating made of the electrode material is formed on the workpiece surface or a coating made of a substance resulting from reaction of the electrode material to the discharge energy is formed on the workpiece surface. Regarding polarities for use, the electrode 5 side has a minus polarity, and the workpiece 6 side has a plus polarity.

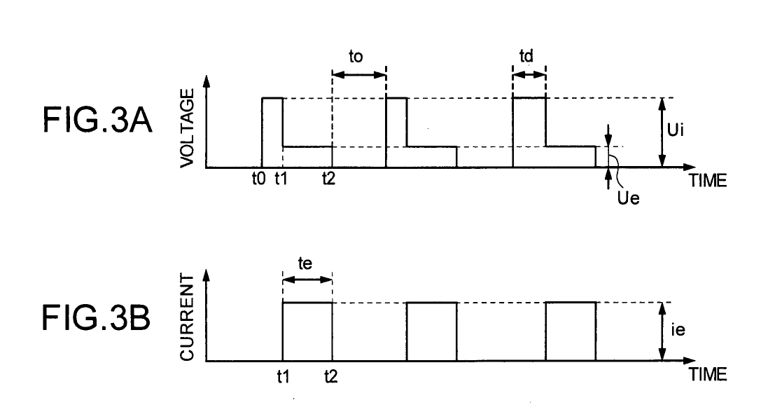

FIGS. 3A and 3B depict an example of pulse conditions of a discharge when a discharge surface treatment is performed in the discharge surface-treatment apparatus having the structure described above. FIGS. 3A and 3B are drawings of the example of pulse conditions of the discharge at the time of the discharge surface treatment, wherein FIG. 3A depicts a voltage waveform (inter-electrode voltage waveform) between the electrode 11 and the workpiece 12 at the time of discharge and FIG. 3B depicts a current waveform of a current flowing the discharge surface-treatment apparatus at the time of discharge. The current value is positive in the direction of an arrow in each of FIGS. 3A and 3B, that is, in the upper direction of the vertical axis. In addition, the voltage value is positive when the electrode 5 side has a minus polarity, whilst the workpiece 6 side is taken as a plus-polarity electrode.

As shown in FIG. 3A, a no-load voltage ui is applied between both poles at a time t0. A current I begins to flow at a time t1 after an electric-discharge delay time td has elapsed, thereby starting discharge. The voltage at this time is an electric-discharge voltage ue, and the current at this time is represented by a peak current value ie. When the supply of the voltage between both poles is stopped at a time t2, the flow of the current stops.

A duration between t2 to t1 is referred to as an electric-discharge pulse width te. A voltage waveform in a duration between t0 to t2 is repeatedly applied between both poles at intervals of a quiescent time to. That is, as shown in FIG. 3A, a pulse-like voltage is applied between the electrode 5 and the workpiece 6.

The pulse conditions used in the first embodiment are such that the peak current value ie=10 amperes, the electric-discharge duration (discharge pulse width) te=64 microseconds, and the quiescent time to=128 microseconds.

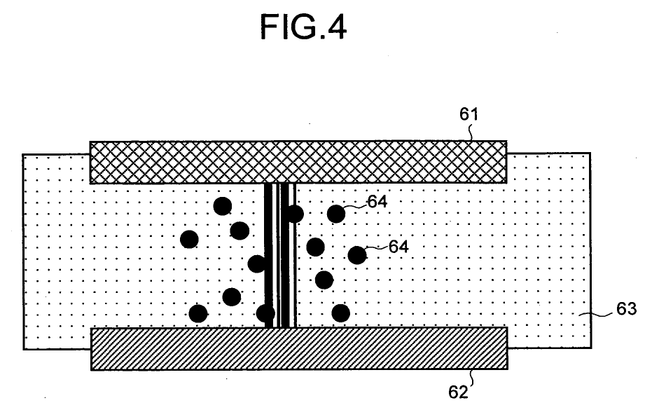

Such a discharge in a gas atmosphere (according to the first embodiment, an argon atmosphere) is different from a discharge in liquid (in dielectric fluid) in that the distance between the electrode and the workpiece, that is, the inter-electrode distance, is short. In a discharge in liquid, such as electric fluid (oil) 63, as shown in FIG. 4, the discharge causes the electrode material discharged from an electrode 61 or a powder (process wastage) 64 generated from the melting of a workpiece 62 are present between the poles (between the electrode 61 and the workpiece 62), thereby inducing a discharge. Therefore, the inter-electrode distance is long.

For reference, under the conditions such that the peak current value ie=10 amperes, the electric-discharge duration (discharge pulse width) te=64 microseconds, the quiescent time to=128 microseconds, and 80 volts of the no-load voltage, the inter-electrode distance during discharge is approximately 40 micrometers to 50 micrometers.

Next, the principle of the present method (discharge surface-treatment method) in a gas atmosphere (according to the first embodiment, in an argon atmosphere) with the structure of FIG. 2 is described. When a discharge occurs, the portion of the arc column 8 between the electrode 5 and the workpiece 6 is heated. The electrode 5 has a low thermal conductivity because the electrode is configured by compressing and forming a Co powder on the order of 1 micrometer, and is partially heated to a such an extent that it is partially vaporized. With an explosive power when the electrode material is partially vaporized, the electrode is blown to the workpiece side to be transferred to the workpiece side, thereby forming a coating on the workpiece surface.

Since the discharge surface treatment in a gas atmosphere has such a principle, for forming a coating on the workpiece surface, the electrode is preferably made of a powder material. If a discharge surface treatment is performed by using an electrode not formed of a powder material, a discharge pulse having large energy is required to blow the electrode material to the workpiece side. However, such a large discharge pulse causes the workpiece side to be removed. That is, when a discharge surface treatment is performed by using an electrode not made of a powder material, it is difficult to melt the electrode with a discharge pulse having small energy as in the first embodiment to blow the material to the workpiece side.

In addition, in the discharge in a gas atmosphere, unlike in dielectric fluid, a discharge inducing operation via process wastage cannot be expected. Therefore, the workpiece and the electrode have to be made close to each other at a distance where a discharge occurs by the applied voltage.

However, since a swell of a discharge trace by the discharge is generated, if the distance between the poles, that is, the distance between the electrode and the workpiece, is too narrowed, the amount of swell of the discharge trace is larger than the inter-electrode distance. In this case, a short is generated between the poles when the electrode material is transferred to the workpiece by the discharge.

Irrespectively of in dielectric fluid or in a gas atmosphere, the amount of the discharge trance based on the conditions is on the order of 10 micrometers to 20 micrometers. Also, in consideration of a not so high response speed (response frequency) of positioning control between the poles (for example, on the order of several tens of hertz), it will be difficult to cause a stable discharge unless an inter-electrode distance equal to or larger than approximately 30 micrometers is ensured.

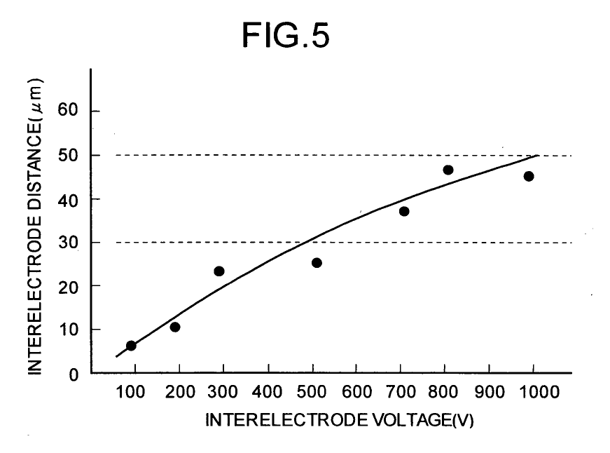

FIG. 5 depicts a graph of a relation between a no-load voltage (inter-electrode voltage) and an inter-electrode distance at the time of a discharge in a gas atmosphere (argon atmosphere). This graph represents measurements obtained from a test for measuring a position at the time of occurrence of a discharge while an apparatus, such as a laser displacement gauge or an eddy-current sensor, for measuring the distance between the poles is used to measure the inter-electrode distance.

Here, this graph provides a summary of the inter-electrode distance and the no-load voltage (inter-electrode voltage) measured when a discharge occurs while the inter-electrode voltage (no-load voltage) is changed under the process conditions such that the peak current value ie=10 amperes, the electric-discharge duration (discharge pulse width) te=64 microseconds, and the quiescent time to=128 microseconds.

As can be known from FIG. 5, the no-load voltage and the inter-electrode distance has a correlation such that as the no-load voltage increases, the inter-electrode distance widens. Therefore, to make a discharge in a gas atmosphere stably proceed, a voltage equal to or large than at least 500 volts is required. Preferably, a no-load voltage (inter-electrode voltage) equal to or larger than approximately 1000 volts is applied. This is required to keep the inter-electrode distance equal to or larger than approximately 30 micrometers.

To control the inter-electrode distance of 30 micrometers, if the response frequency for inter-electrode distance control can be kept at an extremely high state, such as 100 hertz or more, the no-load voltage (inter-electrode voltage) may be equal to or larger than approximately 300 volts. However, to configure the actual processing apparatus, the response frequency obtained is on the order of 10 hertz to 20 hertz at best. Therefore, a sufficient inter-electrode voltage equal to or larger than approximately 500 volts is required.

A reason for requiring a no-load voltage (inter-electrode voltage) equal to or larger than 500 volts, preferably, equal to or larger than 1000 volts is that the voltage is to cause a stable discharge, and this does not depend on the electrode material or the like. However, when the intensity of the electrode is low and the electrode material is excessively supplied between the poles by the discharge, for example, a much higher no-load voltage (inter-electrode voltage) may be required in some cases.

Examples of a coating processing method using a discharge in a gas atmosphere are disclosed in Japanese Patent Application Laid-Open Publication No. 6-269936, Japanese Patent Application Laid-Open Publication No. 6-269939, and Japanese Patent Application Laid-Open Publication No. 9-108834. These inventions use a discharge in a gas atmosphere, and has a principle in which a discharge is generated between a metal electrode rotating at high speed and the workpiece and the electrode material melt by the discharge is made contact with the workpiece to be adhered thereto. However, these inventions are different from technologies in which, as in the present invention, a predetermined inter-electrode space is formed between the workpiece and the electrode by using an electrode of a molded-powder and, with a pulse discharge, the electrode material is transferred to the workpiece surface.

Here, these conventional technologies require manual operations, and it is difficult to stably form a coating. Moreover, such technologies cannot support automation.

According to the first embodiment, in a gas atmosphere, a voltage equal to or larger than 500 volts is applied between the electrode and the workpiece to cause a pulse-like discharge for performing a discharge surface treatment, thereby forming an excellent thick coating even in a gas atmosphere. Therefore, instead of coating formation in dielectric fluid, discharge surface treating technology in a gas atmosphere can be established. With this, a coating can be formed even without dielectric fluid, such as oil.

In addition, the method is described in which the powder is formed by compression molding with press, as the method of molding an electrode for electric-discharge surface treatment. However, the method of manufacturing an electrode for electric discharge surface treatment is not restricted to compression molding, but may be any other forming method as long as the powder is molded. Examples of the method of forming the electrode include, in addition to compression molding with press or the like as described above, slip casting, Metal Injection Molding (MIM), spraying, and molding with nanopowder-entrained jet stream. This will be applied to following embodiments in the same manner.

The slip casting is a method of molding a powder by putting the powder dispersed in a solvent into a porous cast, such as a plaster mold, and then removing the solvent. The MIM is a molding method of injecting a binder-kneaded powder into a heated mold. The spraying is a method of spraying a heated powder to mold a partially-bound powder. The exemplary methods described above are different from each other in the molding method, but the object of molding a powder is the same. Therefore, any of these methods can be used as a method of forming the electrode as long as a desired binding state of the powder is obtained.

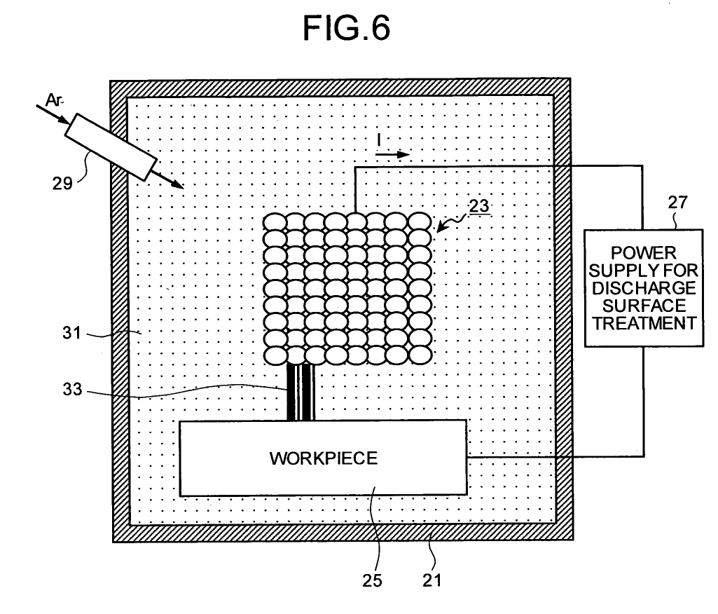

A discharge surface method according to a second embodiment of the present invention is described with reference to FIG. 6. FIG. 6 is a conceptual view of a state of performing a discharge surface treatment by a discharge surface-treatment apparatus according to the second embodiment. As shown in FIG. 6, the state of occurrence of a pulse-like discharge is shown.

In the discharge surface-treatment apparatus according to the second embodiment shown in FIG. 6, a chamber 21 accommodates an electrode for discharge surface treatment 23 (which may be hereinafter simply an electrode 23), a workpiece 25, and others. The electrode 23 is an electrode formed of a titanium (Ti) powder. The electrode 23 and the workpiece 25 are each connected to a power supply for discharge surface treatment 27 provided outside of the chamber 21 for causing a pulse-like discharge (arc column 33) by applying a voltage between the electrode 23 and the workpiece 25. In this structure, a current I at the time of discharge flows toward a direction from the electrode 23 to the power supply for discharge surface treatment 27.

In addition, the chamber 21 is provided with a gas supply opening 29 for supplying gas in the chamber 21. Through the gas supply opening 29, gas is supplied into the chamber 21. Therefore, in this discharge surface-treatment apparatus, the discharge surface treatment is performed in a gas atmosphere. According to the second embodiment, it is assumed that argon (Ar) gas 31 is introduced in the chamber 21 via the gas supply opening 29, and the chamber is in an argon atmosphere.

Here, in FIG. 6, a servo mechanism for controlling an inter-electrode distance, that is, a distance between the electrode 23 and the workpiece 25 and others are not directly related to the present invention, and therefore are omitted herein.

Here, a titanium (Ti) powder forming the electrode 23 is difficult to be pulverized. Thus, according to the second embodiment, titanium hydride (TiH₂) powder is crushed so as to be on the order of 2 micrometers to 3 micrometers, and is then compressed, molded, and heated to cause hydrogen to be ejected, thereby manufacturing the electrode 23.

The principle of coating formation including process conditions is similar to that according to the first embodiment described above, in which a pulse-like discharge is generated between the electrode 23 and the workpiece 25 for making the electrode material transferred to the workpiece side.

According to the second embodiment, the electrode 23 and the workpiece 25 are accommodated in the chamber 21 blocked from outside air. Into the chamber 21, argon (Ar) 31, which is an inert gas, is supplied from the gas supply opening 29.

According to the first embodiment, the case of using a Co electrode has been described. Co is a material resistant to oxidation. Therefore, even by using the Co electrode to perform a discharge surface treatment and cause a discharge in air, a Co coating can be formed on the workpiece.

However, as in the second embodiment, when a discharge is generated in air with the use of a material, such as titanium (Ti), having a high chemical reactivity, Ti immediately becomes titanium oxide (TiO₂).

Titanium oxide has characteristics of a ceramic and a low thermal conductivity, for example, which are different from those of metal. Therefore, it is impossible to form a thick coating whose main ingredient is titanium by causing a discharge in air.

To get around this problem, according to the second embodiment, an Ar gas 31 is used to suppress such chemical reaction of the electrode material to the discharge. The inert gas (noble gas), such as the Ar gas 31, suppresses a change of the electrode to become anther substance. With this, by using the inert gas (noble gas), such as the Ar gas 31, even an electrode material, such as Ti, prone to cause chemical reaction can be transferred to the workpiece side as in the state of the metal of Ti, thereby forming a Ti coating on the workpiece surface.

That is, since this discharge surface-treatment apparatus performs a discharge surface treatment in an inert gas atmosphere, an effect can be achieved such that, even an electrode material, such as Ti, prone to cause chemical reaction can be transferred to the workpiece side as in the state of the metal of Ti, thereby forming a Ti coating on the workpiece surface.

To achieve this object, a gas to be introduced into the chamber 21 is not restricted to Ar gas, but another inert gas (noble gas), such as helium (He) gas or neon (Ne) gas, or an inert gas such as nitrogen can be used.

According to the second embodiment, a discharge surface treatment is performed with the electrode 23, the workpiece 25, and others being accommodated in the chamber 21. However, the electrode 23, the workpiece 25, and others do not necessarily have to be accommodated in the chamber 21, and all what is needed is that the environment where a discharge occurs is in an inert gas atmosphere, such as Ar. For example, the structure and method may be such that an inert gas is supplied from a location near the electrode 23 toward a location near a discharge point. In addition, in this case, an effect similar to the above can be obtained.

One problem in discharge in a gas atmosphere is heating of the electrode by discharge. When a discharge is generated in liquid, even if the electrode is locally heated by discharge energy, the electrode is immediately cooled. However, when a discharge is generated in a gas atmosphere, cooling is difficult to proceed. Therefore, when a discharge is generated in a gas atmosphere, the temperature of the electrode is increased, and the degree of hardness (hardness) of the electrode is increased. When the hardness of the electrode is increased, the electric resistance of the electrode is decreased. Due to this, the discharge voltage becomes a low voltage compared with a normal value.

As such, when the hardness of the electrode is high, that is, when the discharge voltage is lower than the normal value, phenomena, such as delayed coating formation and removal of the workpiece, occur. To get around this, when a discharge is generated in a gas atmosphere, cooling the electrode is required.

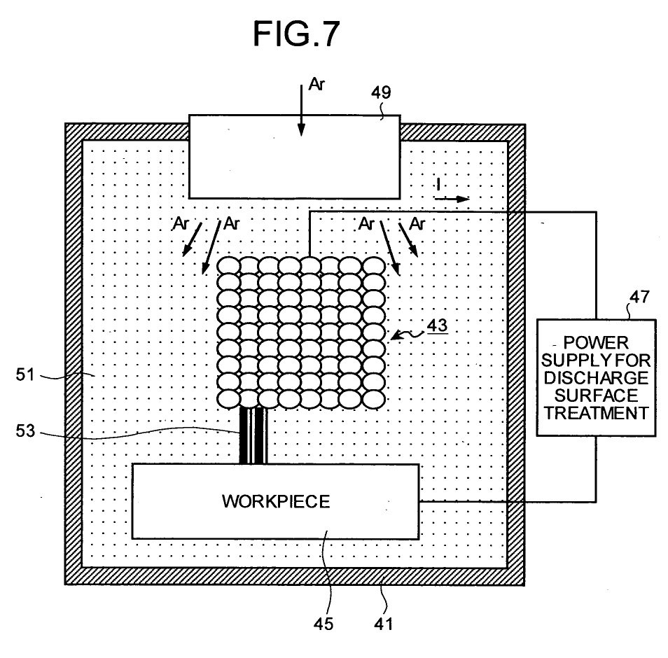

According to a third embodiment of the present invention, a method of cooling the electrode is described by using FIG. 7. FIG. 7 is a conceptual view of a state of performing a discharge surface treatment by a discharge surface-treatment apparatus according to the third embodiment. In FIG. 7, the state of occurrence of a pulse-like discharge is shown.

In the discharge surface-treatment apparatus according to the third embodiment shown in FIG. 7, a chamber 41 accommodates an electrode for discharge surface treatment 43 (which may be hereinafter simply an electrode 43), a workpiece 45, and others. The electrode 43 and the workpiece 45 are each connected to a power supply for discharge surface treatment 47 provided outside of the chamber 41 for causing a pulse-like discharge (arc column 53) by applying a voltage between the electrode 43 and the workpiece 45. In this structure, a current I at the time of discharge flows toward a direction from the electrode 43 to the power supply for discharge surface treatment 47.

In addition, the chamber 41 is provided with a gas supply opening 49 for supplying gas in the chamber 21 and cooling the electrode. Therefore, in this discharge surface-treatment apparatus, gas is supplied via the gas supply opening 49 into the chamber 41. In addition, the gas supplied via the gas supply opening 49 is set to be applied to the electrode 43 when introduced in the chamber 41. According to the third embodiment, it is assumed that an argon (Ar) gas 51 is introduced in the chamber 41 via the gas supply opening 49, and the chamber is in an argon atmosphere.

Here, in FIG. 7, a servo mechanism for controlling an inter-electrode distance, that is, a distance between the electrode 43 and the workpiece 45 and others are not directly related to the present invention, and therefore are omitted herein.

The principle of coating formation including process conditions is similar to that according to the first embodiment described above, in which a pulse-like discharge is generated between the electrode 43 and the workpiece 45 for making the electrode material transferred to the workpiece side.

The Ar gas 51 supplied via the gas supply opening 49 is set so as to be applied to the electrode 43. With this, in this discharge surface-treatment apparatus, the chamber 41 is filled with the Ar gas 51, and the electrode 43 is cooled, thereby preventing the electrode 43 from being heated.

As a result, the electrode 43 can be effectively cooled, thereby preventing the hardness of the electrode 43 from being increased. Therefore, in this discharge surface-treatment apparatus, changes in the state of the electrode 43 in the course of the discharge surface treatment can be prevented, thereby achieving an effect such that a coating can be stably formed even if a processing time has elapsed.

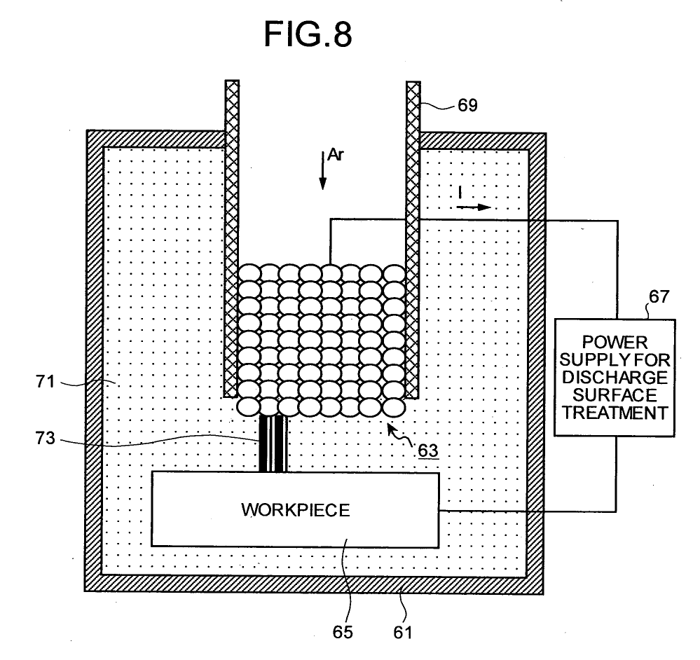

As with the third embodiment described above, an object of a fourth embodiment of the present invention is to solve heating of the electrode by a discharge, which is a problem in a discharge in a gas atmosphere. With reference to FIG. 8, a method of cooling the electrode according to the fourth embodiment is described. FIG. 8 is a conceptual view of a state of performing a discharge surface treatment by a discharge surface-treatment apparatus according to the fourth embodiment. In FIG. 8, the state of occurrence of a pulse-like discharge is shown.

In the discharge surface-treatment apparatus according to the fourth embodiment shown in FIG. 8, a chamber 61 accommodates an electrode for discharge surface treatment 63 (which may be hereinafter simply an electrode 63), a workpiece 65, and others. The electrode 63 is an electrode formed of a titanium (Ti) powder. The electrode 63 and the workpiece 65 are each connected to a power supply for discharge surface treatment 67 provided outside of the chamber 61 for causing a pulse-like discharge (arc column 73) by applying a voltage between the electrode 63 and the workpiece 65. In this structure, a current I at the time of discharge flows toward a direction from the electrode 63 to the power supply for discharge surface treatment 67.

In addition, the chamber 61 is provided with a gas supply opening 69 for supplying gas in the chamber 61 and cooling the electrode. Therefore, in this discharge surface-treatment apparatus, gas is supplied via the gas supply opening 69 into the chamber 61. In addition, the gas supplied via the gas supply opening 69 is set to be applied to the electrode 63 when introduced in the chamber 61. According to the fourth embodiment, it is assumed that argon (Ar) gas 71 is introduced in the chamber 61 via the gas supply opening 69, and the chamber 61 is in an argon atmosphere.

Here, in FIG. 8, a servo mechanism for controlling an inter-electrode distance, that is, a distance between the electrode 63 and the workpiece 65 and others are not directly related to the present invention, and therefore are omitted herein.

The principle of coating formation including process conditions is similar to that according to the first embodiment described above, in which a pulse-like discharge is generated between the electrode 63 and the workpiece 65 for making the electrode material transferred to the workpiece side.

According to the fourth embodiment, the Ar gas 71 is supplied to the gas supply opening 69, thereby supplying the Ar gas 71 via the electrode 63 into the chamber 61. The electrode 63 has a porous structure formed of a powder, allowing gas to pass therethrough. With this, in this discharge surface-treatment apparatus, the chamber 61 is filled with the Ar gas 71, and the electrode 63 is cooled, thereby preventing the electrode 63 from being heated.

At this time, as shown in FIG. 8, the periphery of the electrode 63 is covered by a member made of a material not allowing gas to pass, thereby making it possible to introducing the Ar gas to a portion where a discharge occurs more efficiently. This can be achieved by, for example, as shown in FIG. 8, having the electrode accommodated in a cylinder. With this, the chamber 61 is filled with the Ar gas 71, and also the electrode 63 is cooled, thereby preventing the electrode 63 from being heated.

As a result, the electrode 63 can be more effectively cooled, thereby preventing the hardness of the electrode 63 from being increased. Therefore, in this discharge surface-treatment apparatus, changes in the state of the electrode 63 in the course of the discharge surface treatment can be prevented, thereby achieving an effect such that a coating can be stably formed even if a processing time has elapsed.

According to the fourth embodiment, since the electrode can be more efficiently cooled to a degree equivalent to that in the case where the electrode is cooled by dielectric fluid at the time of a discharge in dielectric fluid. As a result, the temperature of the electrode is always kept in a good state. Therefore, changes in the temperature of the electrode do not affect the electric-discharge coating formation characteristic, thereby making it possible to form a better coating.

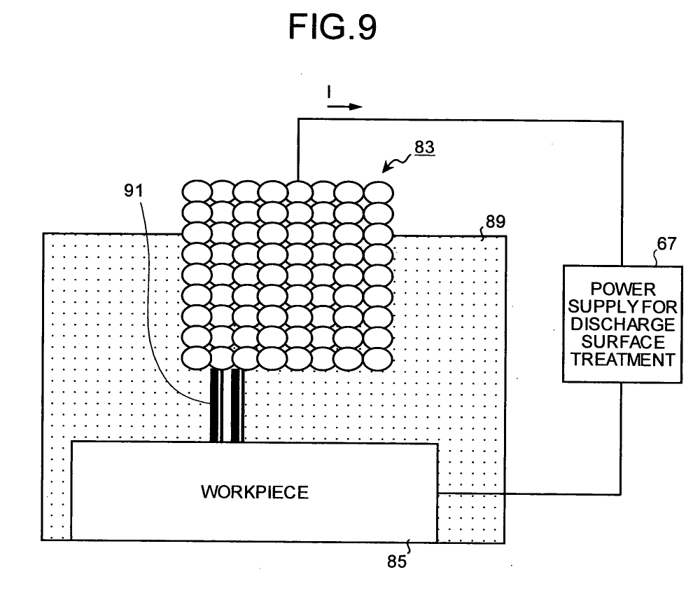

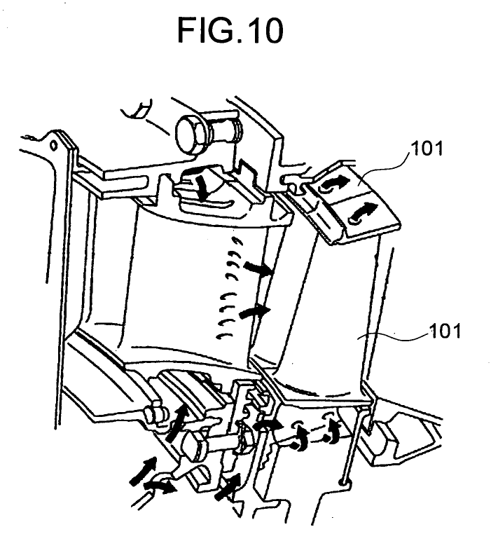

A discharge surface-treatment method according to a fifth embodiment of the present invention is described by using FIG. 9. FIG. 9 is a conceptual view of a state of performing a discharge surface treatment by a discharge surface-treatment apparatus according to the fifth embodiment. In FIG. 9, the state of occurrence of a pulse-like discharge is shown.

As shown in FIG. 9, the discharge surface-treatment apparatus according to the fifth embodiment includes an electrode for discharge surface treatment 83 (which may be hereinafter simply an electrode 5); liquid argon 89, which is dielectric fluid covering the electrode 83 and a workpiece 85; and a power supply for discharge surface treatment 87 that causes a pulse-like discharge (arc column 91) by applying a voltage between the electrode 83 and the workpiece 85. Here, in FIG. 9, a servo mechanism for controlling an inter-electrode distance, that is, a distance between the electrode 83 and the workpiece 85, a depot that stores the liquid argon 89, and others are not directly related to the present invention, and therefore are omitted herein.

The principle of coating formation including process conditions is similar to that according to the first embodiment described above, in which a pulse-like discharge is generated between the electrode 63 and the workpiece 65 for making the electrode material transferred to the workpiece side.

According to the fifth embodiment, the discharge surface treatment in an inert gas atmosphere has been described as a scheme of preventing the electrode material melted by a discharge energy from being carbonized or oxidized. With liquefied inert gas being used as dielectric fluid, a coating can be formed in a manner similar to that in the discharge surface treatment in liquid.

However, in fact, there is a drawback that measures have to be taken against an extremely low temperature of the discharge surface-treatment apparatus.

As for a process in a gas atmosphere, the process can be performed relatively easily even in nitrogen gas. However, there is a problem in which nitriding of the coating easily proceeds in a process in liquid nitrogen.

Even with the drawbacks as described above, in this electrode for discharge surface treatment, the electrode for discharge surface treatment is performed in liquid, and therefore, excellent stability in discharge and coating formation can be achieved. In addition, there are advantages that cannot be achieved by a discharge in a gas atmosphere, such that a stable discharge is possible without increasing a no-load voltage (inter-electrode voltage) to 500 volts, thereby simplifying the circuitry configuration.

That is, in the discharge surface treatment in liquid argon, unlike the embodiment described above, a process condition of 500 volts does not have to be satisfied, and the process can be performed at a no-load voltage (inter-electrode voltage) lower than 500 volts (which is a no-load voltage (inter-electrode voltage) in a normal discharge process).

A reason why the no-load voltage (inter-electrode voltage) can be decreased when a discharge surface treatment is performed in liquid obtained by liquefying inert gas is that a process powder generated by the discharge stay in liquid, thereby inducing a discharge.

According to the first to the fifth embodiments, an electrode for discharge surface treatment formed of a powder is used as an electrode for discharge surface treatment. Studies of the inventors have found that, if the electrode for discharge surface treatment is easily consumed, similar effects can be achieved even with the electrode being in a metal state without being pulverized.

For example, when aluminum (100 percent of aluminum, aluminum alloy) is used as the electrode for discharge surface treatment, the electrode for discharge surface treatment is easily consumed due to a discharge pulse to be transferred to the workpiece side. Here, as for the aluminum electrode, electrode consumption by discharge is so large that the electrode material as much as the powder electrode made of another material is dispersed toward the workpiece side.

Then, when aluminum dispersed toward the workpiece side covers the workpiece, the aluminum surface is oxidized under a high temperature environment, thereby preventing the workpiece from being oxidized. This is because aluminum on the surface is oxidized to form an oxidized coating and this oxidized coating prevents oxidation from proceeding to the inside of the workpiece.

Conventionally, an aluminum coating is formed on the workpiece through a complex process called an aluminizing process. With a pulse discharge, an aluminum coating can now be easily formed.

When a process of forming such a participation coating in dielectric fluid, such as oil, carbon enters the coating, which may be undesirable in some cases. When carbon enters the coating, carbon may be precipitated to decrease the coating strength after a predetermined time passes, or carbide may be formed in the coating. To avoid this, the discharge surface treatment is preferably performed in argon, but even with oil, generally speaking, a sufficient effect can be achieved in some case.

In addition, when a discharge surface treatment is performed in a gas atmosphere, as with the embodiments described above, a voltage equal to or larger than 500 volts is preferably applied between the electrode and the workpiece to cause a pulse-like discharge for performing an electrode for discharge surface treatment. With this, an excellent coating can be formed by using an aluminum electrode even in a gas atmosphere.

According to the a sixth embodiment of the present invention, aluminum can be used as an electrode for discharge surface treatment without being pulverized, and an aluminum coating can be easily formed on a workpiece.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A discharge surface-treatment method comprising:
generating a pulse-like discharge by using a green compact of metal powder, a metal compound powder, or a ceramic powder as an electrode and applying a voltage equal to or greater than 500 volts between the electrode and a workpiece in a gas atmosphere; and
forming a coating consisting of an electrode material or a substance resulting from a reaction of the electrode material to the energy of the pulse-like discharge on a surface of the workpiece with an energy of the pulse-like discharge.

2. The discharge surface-treatment method according to claim 1, wherein the gas atmosphere is an inert gas atmosphere.

3. The discharge surface-treatment method according to claim 1, wherein the discharge is generated while the electrode is cooled.

4. The discharge surface-treatment method according to claim 3, wherein the electrode is cooled by passing a gas through the electrode.

5. The discharge surface-treatment method according to claim 4, wherein
the electrode is accommodated in a gas-impermeable cylinder, and
the gas is supplied into the cylinder to cool the electrode, and at the same time, supplied to an area where the discharge is generated.

6. A discharge surface-treatment apparatus comprising:
an electrode formed of a green compact of metal powder, a metal compound powder, or a ceramic powder;
a power supply that applies a voltage equal to or greater than 500 volts between the electrode and a workpiece to generate a pulse-like discharge; and
a gas supplying unit that supplies a gas to the electrode and the workpiece, wherein
a coating consisting of an electrode material or a substance resulting from a reaction of the electrode material to the energy of the pulse-like discharge is formed on a surface of the workpiece with an energy of the pulse-like discharge.

7. The discharge surface-treatment apparatus according to claim 6, wherein the gas supplied by the gas supplying unit is an inert gas.

8. The discharge surface-treatment apparatus according to claim 6, further comprising a case enclosing the electrode and the workpiece, wherein
the air supplying unit supplies an inert gas into the case, and
the coating is formed in an inert gas atmosphere.

9. The discharge surface-treatment apparatus according to claim 6, wherein the electrode is cooled by supplying the gas from the gas supplying unit.

10. The discharge surface-treatment apparatus according to claim 6, wherein
the electrode is accommodated in a gas-impermeable cylinder, and
the gas is supplied into the cylinder to cool the electrode.

11. A discharge surface-treatment method comprising:
generating a pulse-like discharge by using a green compact of metal powder, a metal compound powder, or a ceramic powder as an electrode and applying a voltage equal to or greater than 500 volts between the electrode and a workpiece in an inert-gas atmosphere in a liquid state; and
forming a coating consisting of an electrode material or a substance resulting from a reaction of the electrode material to the energy of the pulse-like discharge on a surface of the workpiece with an energy of the pulse-like discharge.

12. A discharge surface-treatment apparatus comprising:
an electrode formed of a green compact of metal powder, a metal compound powder, or a ceramic powder;
a storing unit that stores an inert gas in a liquid state; and
a power supply that generates a pulse-like discharge between the electrode and a workpiece; wherein
a coating consisting of an electrode material or a substance resulting from a reaction of the electrode material to the energy of the pulse-like discharge is formed on a surface of the workpiece with an energy of the pulse-like discharge.

13. A discharge surface-treatment method comprising:
generating a pulse-like discharge by using a metal mainly consisting of an aluminum as an electrode and applying a voltage equal to or greater than 500 volts between the electrode and a workpiece in a gas atmosphere, or in a working liquid; and
forming a coating consisting of an electrode material or a substance resulting from a reaction of the electrode material to the energy of the pulse-like discharge on a surface of the workpiece with an energy of the pulse-like discharge.

14. The discharge surface-treatment method according to claim 13, wherein the gas atmosphere is an inert gas atmosphere.
